(19) United States
(12) Patent Application Publication
(10) Pub. No.: US 2002/0154343 A1
(43) Pub. Date: Oct. 24, 2002

(54) System and method of capturing a digital picture

(75) Inventors: Chui-Kuei Chiu, Hsin-Chu (TW); Yin-Chun Huang, Hsin-Chu (TW)

Correspondence Address: LOWE HAUPTMAN GILMAN& BERNER, LLP, 1700 Diagonal Road, Suite 310, Alexandria, VA, 22314, US

(73) Assignee: UMAX DATA SYSTEMS INC.

(21) Appl. No.: 09/839,208

(22) Filed: Apr. 23, 2001

(51) Int. Cl. H04N 1/04

(52) U.S. Cl. 358/474; 358/452

(57) ABSTRACT

The present invention provides a method and a system of display interface for an image copy machine. The system comprises a preview module for displaying previewed digital pictures. A preferred module is for storing several settings, such as resolution or brightness that are corresponding to the previewed digital pictures. A control module is for commanding the image copy machine to translate image data into an objective digital picture. The method comprises previewing multitudes of previewed pictures on a display device for the objective image. An objective picture is generated for the objective image. The corresponding objective settings are added to the corresponding previewed settings. Users can get the objective picture without knowing the corresponding settings.

### BACKGROUND OF THE INVENTION

1. Field of the Invention

The invention relates to a method and system of capturing a digital picture, and more particularly to a method and apparatus of capturing the digital picture of an image with a scanner.

2. Description of the Prior Art

In recent years, a digital copying machine has had various functions for processing a document image, such as black-and-white inversion, mirroring, inside-blanking, or image separation. In addition, a color digital copying machine also has other color processing functions, such as color conversion or color deletion. Users select a desired image area or any one of the functions described above for a particular image on an operating zone or with an editor to set conditions for image processing. In this case, users generally output a trial copy to check whether a desired image quality can be obtained or not, and then enables the user to execute fine adjustment in a case where a desired image quality has not been obtained, and again outputs a trial copy for checking finishing of the outputted copy.

As depicted in FIG. 1, when users would like to capture the digital picture of an objective image, a dialog box 110 is displayed in an image processing software. The dialog box 110 generally comprises a preview zone 111, a setting zone 112, a preview button 113, and a scanning button 114. The objective digital picture may be previewed in the preview zone 111 and configured with several functional settings in the setting zone 112. The preview button 113 provides users capturing a previewed digital picture that is shown in the preview zone 111. Once users are satisfied with the previewed digital picture, they may select the scanning button 114 to command a scanner to execute the scanning process.

FIG. 2 is a flow chart illustrating an image-captured process.

Users may get a defaulted previewed picture or a preliminarily previewed one with preliminary configurations (step 120). If users aren't satisfied with the defaulted or preliminary picture, they need to adjust those settings for scanning (step 121) and then preview the renewed previewed picture. For those users unfamiliar with image processing software, they would execute multitudes of trials of settings to preview before commanding the scanner to execute scanning process (step 123). Accordingly, conventional image process software is not user-friendly toward users.

### SUMMARY OF THE INVENTION

It is an object of the present invention to provide a method and system of interface operation corresponding to a digital copy machine. There are multitudes of predetermined effects displayed for previewing an objective image.

It is another object of the present invention to provide a method and apparatus of interface operation corresponding to a scanner. Through the interface operation, users can directly select a scanning effect for the objective image without knowing anything concerned with image processing.

In the present invention, a method and a system of display interface for an image copy machine. The system comprises a preview module for displaying previewed digital pictures. A preferred module is for storing several settings, such as resolution or brightness that are corresponding to the previewed digital pictures. A control module is for commanding the image copy machine to translate image data into an objective digital picture. The method comprises previewing multitudes of previewed pictures on a display device for the objective image. An objective picture is generated for the objective image. The corresponding objective settings are added to the corresponding previewed settings. Users can get the objective picture without knowing the corresponding settings.

### BRIEF DESCRIPTION OF THE DRAWINGS

A better understanding of the invention may be derived by reading the following detailed description with reference to the accompanying drawings including a color one wherein:

FIG. 1 is a schematic diagram illustrating a display screen providing users previewing, setting, and scanning an objective digital image in accordance with the prior art;

FIG. 2 is a flow chart illustrating the tasks of previewing, setting, and scanning on the display screen in accordance with the prior art;

FIG. 3 is a schematic diagram illustrating a display screen providing users previewing, preferred previewing, setting, and scanning an objective digital image in accordance with the present invention;

FIG. 4 is a colorish schematic diagram illustrating the contents in the preferred preview zone of the display screen in accordance with the present invention; and

FIG. 5 is a schematic diagram illustrating the system of the interface operation in accordance with the present invention.

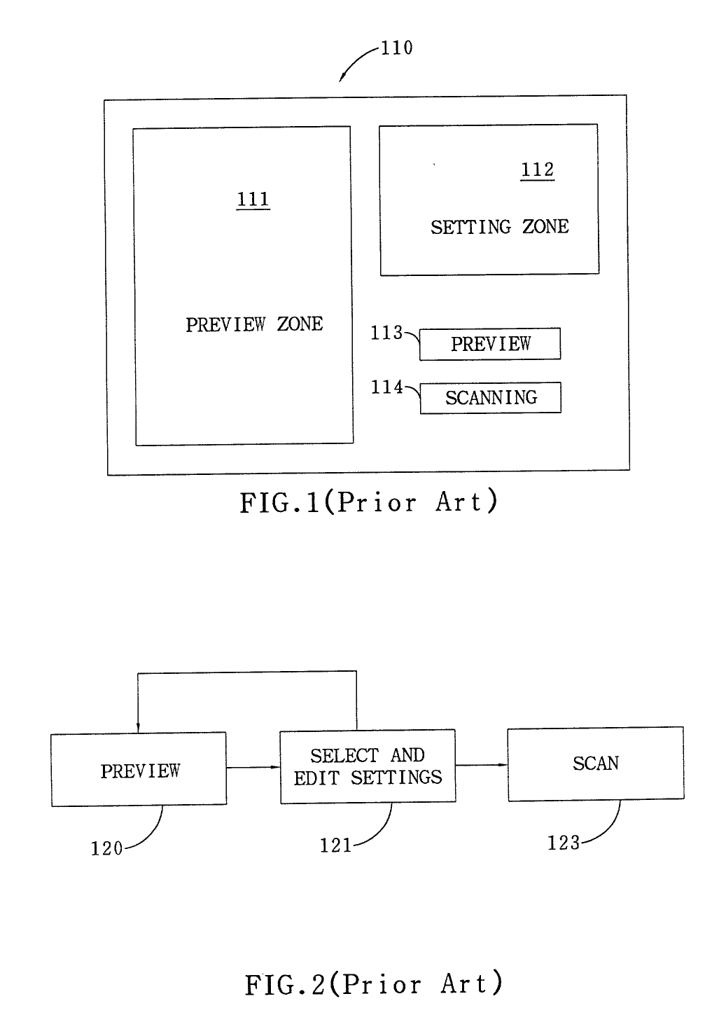

### DESCRIPTION OF THE PREFERRED EMBODIMENT

While the invention is described in terms of a single preferred embodiment, those skilled in the art will recognize that many steps described below can be altered without departing from the spirit and scope of the invention.

Furthermore, there is shown a representative portion of display interface of the present invention in enlarged. The drawings are not necessarily to scale to clarify the illustration and should not be interpreted in a limiting sense. Accordingly, these regions will have other conventionally functional zones, when viewed in an actual application.

In the present invention, a method and a system of display interface for an image copy machine. The system comprises a preview module for displaying previewed digital pictures. A preferred module is for storing several settings, such as resolution or brightness that are corresponding to the previewed digital pictures. A control module is for commanding the image copy machine to translate image data into an objective digital picture. The method comprises previewing multitudes of previewed pictures on a display device for the objective image. An objective picture is generated for the objective image. The corresponding objective settings are added to the corresponding previewed settings. Users can get the objective picture without knowing the corresponding settings.

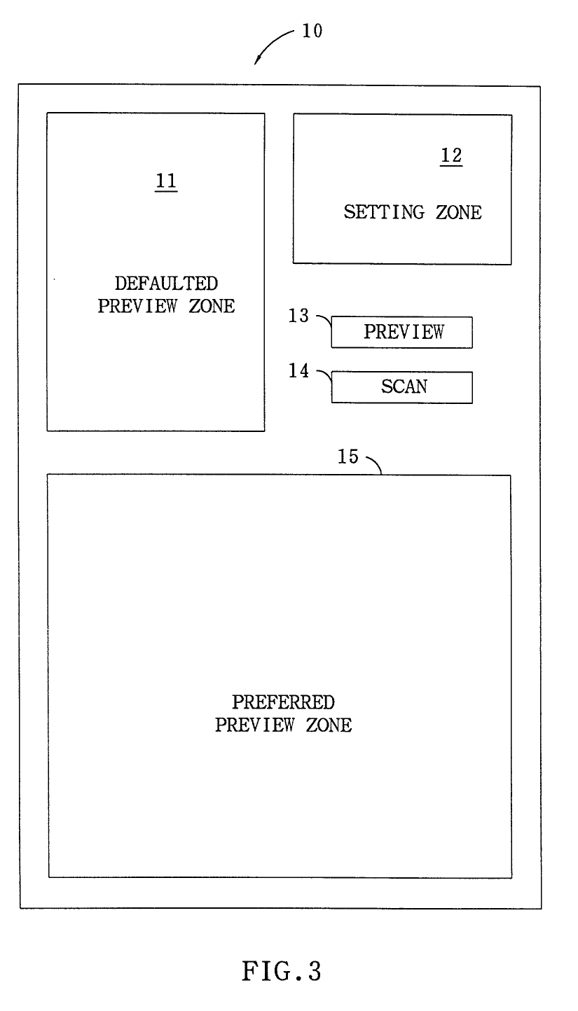

As depicted in FIG. 3, when users would like to capture the digital picture of an objective image, a dialog box 10 is displayed in the operation interface of an image processing software. The dialog box 10 generally comprises a defaulted preview zone 11, a setting zone 12, a preview button 13, a scanning button 14, and a preferred preview zone 15 in addition. The objective digital picture can be previewed in the defaulted preview zone 11 and configured with several functional settings, such as resolution, gamma correction, or brightness, in the setting zone 12. The preview button 13 provides users capturing a previewed digital picture that is shown in the defaulted preview zone 11.

In addition, there are several pictures with various configurations shown in the preferred preview zone 15 when the objective digital picture is previewed. The predetermined configurations corresponding to the objective digital picture provide a quick option for users when selecting a specific effect for the objective digital picture. Users can quickly select the objective digital picture with the specific effect, even they aren't familiar with those settings concerned with the objective digital picture. When users select the specific effect shown in the preferred preview zone 15, the settings related to the selected effect are displayed in the setting zone 12. Users also can design other desired configurations or modify the configuration of the selected effect in the setting zone 12.

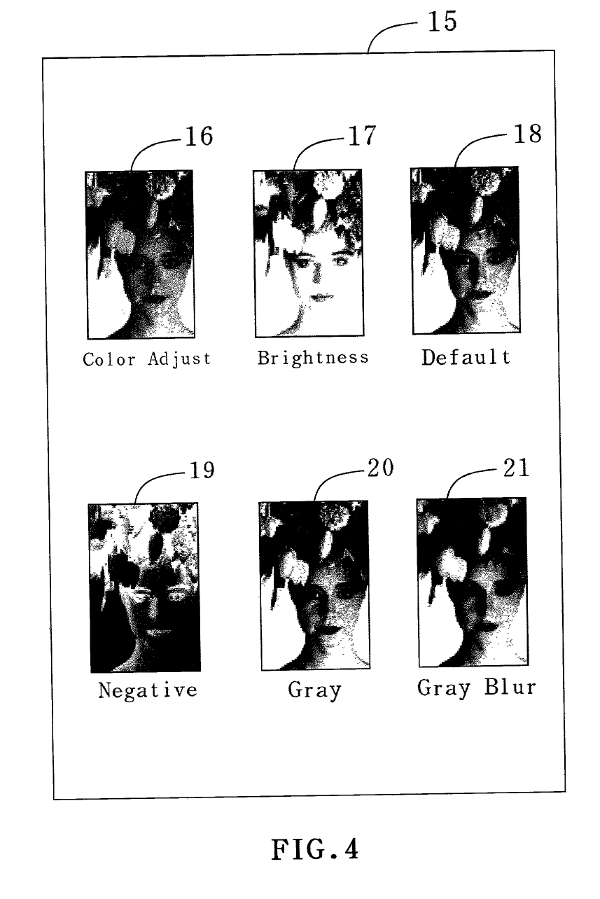

Shown in FIG. 4, in one embodiment, there are multitudes of various effects provided in the preferred preview zone 15, such as color adjust 16, brightness 17, default 18, negative 19, gray 20, and gray blur 21, etc. Users can also design any configuration in the setting zone 12 and add them to the preferred preview zone 15. When users command the scanner to execute the scanning process, the present invention stores the configuration of the scanned image and displays the corresponded effect in the preferred preview zone 15 next time.

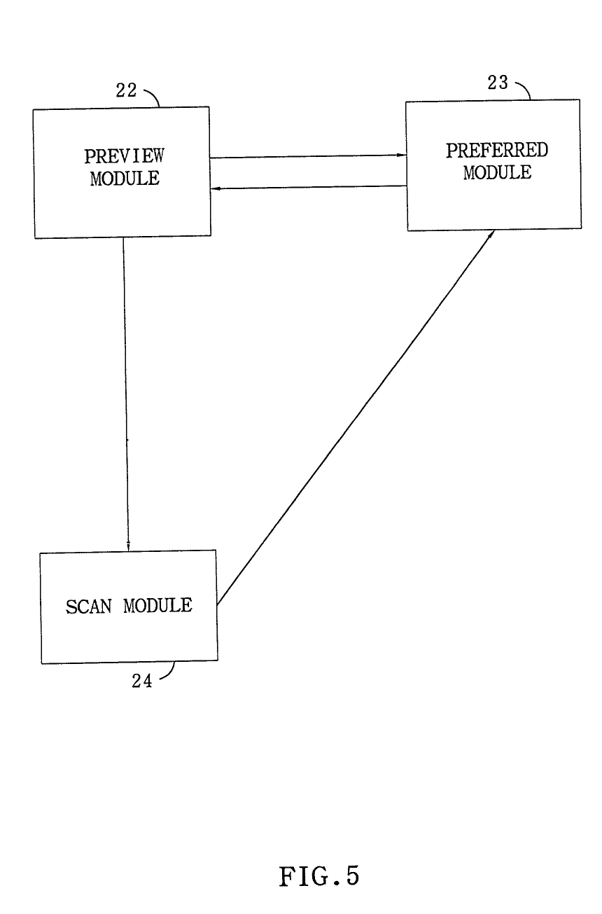

FIG. 5 shows a systemic diagram illustrating the system of the operation interface in accordance with the present invention. A preview module 22 is responsible for displaying the previewed pictures in the operation interface. The previewed pictures comprise one shown in the defaulted preview zone 11 and others shown in the preferred preview zone 15 in FIG. 3. A preferred module 23 is responsible for storing the configurations for the previewed pictures. A scan module 24 is responsible for commanding the scanning process according to the selected configuration. On the other hand, when the scanning process is implemented, the selected configuration for the scanned image will be automatically stored in the preferred module 23. When the other objective image is previewed, the previewed picture with the prior selected configuration is also shown on the operation interface by the preview module 22.

While this invention has been described with reference to illustrative embodiments, this description is not intended to be construed in a limiting sense. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A system of display interface for an image copy machine, said system comprising:
a preview module for displaying a plurality of previewed digital pictures for an objective image;
a preferred module for storing a plurality of settings, said settings corresponding to said previewed digital pictures; and
a control module for commanding said image copy machine to input data of said objective image and translating said data into an objective digital picture.

2. The system according to claim 1 further comprising a setting module for inputting and changing said settings.

3. The system according to claim 1, wherein said preferred module comprises automatically storing a plurality of objective settings of said objective digital picture.

4. The system according to claim 1, wherein said objective digital picture is not one of said previewed digital pictures.

5. The system according to claim 1, wherein said objective digital picture is one of said previewed digital pictures.

6. The system according to claim 1, wherein said image copy machine comprises a scanner.

7. A storage apparatus storing a plurality of computer-readable program for communicating with an image copy machine, said computer-readable program enabling to execute the following steps:
simultaneously displaying a plurality of previewed digital pictures for an objective image, each said previewed digital picture having a plurality of corresponding previewed settings;
generating an objective digital picture for said objective image, said objective digital picture having a plurality of objective settings; and
adding said objective settings to said corresponding previewed settings.

8. The storage apparatus of claim 7 further comprising enabling to executing the steps of editing said corresponding previewed settings and predetermining said objective settings.

9. The storage apparatus of claim 7, wherein said image copy machine comprises a scanner.

10. A method of capturing a digital picture for an objective image, said method comprising:
displaying a plurality of previewed pictures on a display device for said objective image, said previewed pictures having a plurality of corresponding previewed settings;
generating an objective picture for said objective image, said objective picture having a plurality of corresponding objective settings; and
adding said corresponding objective settings to said corresponding previewed settings.

11. The method according to claim 10 further comprising editing said corresponding previewed settings and said corresponding objective settings.

12. The method according to claim 10, wherein said objective image comprises captured by a scanner.

13. The method according to claim 10, wherein said objective picture comprises selected from said previewed pictures.

14. The method according to claim 10, wherein said corresponding previewed settings comprises a capturing resolution.
